(19) United States
(12) Patent Application Publication
(10) Pub. No.: US 2022/0319152 A1
(43) Pub. Date: Oct. 6, 2022

(54) METHODS FOR GENERATING COGNITIVE BUILDING BLOCKS

(71) Applicant: FUVI COGNITIVE NETWORK CORP., Sherborn, MA (US)

(72) Inventor: Phu-Vinh NGUYEN, Sherborn, MA (US)

(21) Appl. No.: 17/711,403

(22) Filed: Apr. 1, 2022

Related U.S. Application Data
(60) Provisional application No. 63/170,162, filed on Apr. 2, 2021.

(51) Int. Cl. G06V 10/774; G06F 16/40; G06V 10/22; G06V 10/94; G06V 10/50

(52) U.S. Cl. CPC G06V 10/774; G06F 16/40; G06V 10/235; G06V 10/945; G06V 10/50

(57) ABSTRACT

Methods and systems for providing cognitive assistance in mastering a concept. The methods involve generating a cognitive template having a number of building blocks that mimic comprehension and learning process of a human mind and generating various content and multimedia data for the concept in the cognitive template, and determining whether cognitive insights and/or cognitive intelligence is being formed with respect to the concept.

### CROSS-REFERENCE TO RELATED APPLICATION

This application claims priority from U.S. Provisional Application No. 63/170,162, filed on Apr. 2, 2021, titled “Methods for Generating Cognitive Building Blocks for Optimizing Human Cognition and Creativity”, the content of which is incorporated herein by reference in its entirety.

### BACKGROUND

### 1. Field

Apparatuses, methods, systems, and computer readable mediums consistent with exemplary embodiments broadly relate to cognitive technology.

### 2. Description of Related Art

In traditional classroom settings, knowledge is considered a collection of facts and procedures transmitted from the teacher to the student. The purpose of conventional education is often times to see who can collect the most facts and thus, the memory becomes a “list-of-facts.” While some techniques utilize scaffolding and user profiles to help the user memorize material for a test, etc., these techniques are not aimed at building cognitive intelligence of a topic and at best, lead to fragmented understanding of the topic and poor retention (the student forgets the memorized material after and sometimes before taking the test).

There is a need for a new approach for teachers and students to move beyond simple memorization of facts without context, and to optimize and enhance the learning experience in ways grounded in neuroscience and reflecting the critical relationship between the brain and the real-world. Techniques are needed to help develop high-order thinking and build cognition.

The above information is presented as background to a state of the computerized arts and only to assist with understanding of the present disclosure. No determination has been made, and no assertions are made that any of the above descriptions are applicable as prior art with regard to the present disclosure. The information presented only describes related art techniques, which could be techniques based on internal knowledge of the Applicant.

### SUMMARY OF EXEMPLARY EMBODIMENTS

In one or more exemplary embodiments, a computerized systems and methods, apparatuses, and computer readable mediums are provided for cognitive assistance.

In one or more exemplary embodiments, a cognitive platform is provided that mimics cognitive processes of a human mind and enables users (such as learners and presenters) to generate cognitively structured data and form cognitive insights and/or cognitive mastery (intelligence).

In one form, a computer-implemented method for cognitive assistance is provided. The method involves generating a cognitive template comprising a plurality of building blocks including a first block for at least one subject, a second block for content associated with the at least one subject, a third block for a map that includes at least one learning objective and at least one link between the at least one subject, the at least one learning objective, and the content, a fourth block for primary episodic units, and a fifth block for semantic meaning of the primary episodic units. The method further involves obtaining user input and multimedia data. Moreover, the method involves adding the at least one subject, the content, and at least one learning objective into the first block, the second block, and the third block, respectively, based on the user input and dividing the multimedia data into a plurality of episodic units. The method also includes adding the plurality of episodic units into the fourth block of the cognitive template and analyzing each of the plurality of episodic units to generate a respective semantic unit that includes semantic meaning of a respective episodic unit. The method further includes adding a plurality of semantic units into the fifth block of the cognitive template, generating a plurality of links between the plurality of semantic units, the plurality of episodic units, the at least one subject, the content, and the at least one learning objective, and adding the plurality of links into the third block in which each of the at least one learning objective is associated with a portion of the content and an episodic set that includes at least two of the plurality of episodic units. Moreover, the method involves providing the multimedia data structured in the cognitive template.

In another form, an apparatus for cognitive assistance is provided. The apparatus includes a memory configured to store computer executable instructions and a processor configured to execute the stored computer executable instructions, which when executed by the processor causes the processor to perform a method. The method includes generating a cognitive template having a plurality of building blocks. The building blocks include a first block for at least one subject, a second block for content associated with the at least one subject, a third block for a map that includes at least one learning objective and at least one link between the at least one subject, the at least one learning objective, and the content, a fourth block for primary episodic units, and a fifth block for semantic meaning of the primary episodic units. The method further includes obtaining user input and multimedia data, adding the at least one subject, the content, and at least one learning objective into the first block, the second block, and the third block, respectively, based on the user input, dividing the multimedia data into a plurality of episodic units, and adding the plurality of episodic units into the fourth block of the cognitive template. The method further includes analyzing each of the plurality of episodic units to generate a respective semantic unit that includes semantic meaning of a respective episodic unit, adding a plurality of semantic units into the fifth block of the cognitive template, and generating a plurality of links between the plurality of semantic units, the plurality of episodic units, the at least one subject, the content, and the at least one learning objective. The method further involves adding the plurality of links into the third block in which each of the at least one learning objective is associated with a portion of the content and an episodic set that includes at least two of the plurality of episodic units and providing the multimedia data structured in the cognitive template.

In yet another form, a non-transitory computer-readable storage media is provided. The non-transitory computer-readable storage media includes code for execution. When the code is executed by a processor, the processor is operable to perform various operations. The operations include generating a cognitive template having a plurality of building blocks. The building blocks include a first block for at least one subject, a second block for content associated with the at least one subject, a third block for a map that includes at least one learning objective and at least one link between the at least one subject, the at least one learning objective, and the content, a fourth block for primary episodic units, and a fifth block for semantic meaning of the primary episodic units. The operations further include obtaining user input and multimedia data and adding the at least one subject, the content, and at least one learning objective into the first block, the second block, and the third block, respectively, based on the user input. The operations further include dividing the multimedia data into a plurality of episodic units, adding the plurality of episodic units into the fourth block of the cognitive template, and analyzing each of the plurality of episodic units to generate a respective semantic unit that includes semantic meaning of a respective episodic unit. The operations further include adding a plurality of semantic units into the fifth block of the cognitive template, generating a plurality of links between the plurality of semantic units, the plurality of episodic units, the at least one subject, the content, and the at least one learning objective, adding the plurality of links into the third block in which each of the at least one learning objective is associated with a portion of the content and an episodic set that includes at least two of the plurality of episodic units, and providing the multimedia data structured in the cognitive template.

In yet another form, another computer-implemented method of cognitive assistance is provided. The method involves generating a cognitive template having a plurality of building blocks that mimic comprehension and learning process of a human mind and adding various content and multimedia data for a concept into the cognitive template and providing various content to one or more users to obtain mastery of the concept. The building blocks include cognitive insights formed based on user interactions with the various content. In one or more example embodiments, the computer-implemented method involves determining if the concept is mastered by a user based on analyzing at least some of the plurality of building blocks.

Illustrative, non-limiting embodiments may overcome the above and below described disadvantages and other disadvantages not described, and also may have been developed to provide solutions to other disadvantages and problems that were not described. However, a method, an apparatus, a system, and a computer readable medium that operates according to the teachings of the present disclosure are not necessarily required to overcome any of the particular problems or disadvantages described. It is understood that one or more exemplary embodiments are not required to overcome the disadvantages described above, and may not overcome any of the problems described above. The appended claims should be consulted to ascertain the true scope of the present disclosure.

### BRIEF DESCRIPTION OF THE DRAWINGS

The accompanying drawings, which are incorporated in and constitute a part of this specification exemplify embodiments and, together with the description, serve to explain and illustrate exemplary embodiments. Specifically:

FIGS. 1A and 1B are comparative views respectively illustrating comprehension obtained, according to a traditional learning process and cognitive insights formed based on a cognitive structure, according to an exemplary embodiment.

FIGS. 2A-C are views illustrating a cognitive platform for generating cognitive building blocks, according to various exemplary embodiments.

FIGS. 3A-3C are views illustrating user interactions with a cognitive platform, according to various exemplary embodiments.

FIGS. 4A and 4B are views illustrating various cognitive building blocks, according to various exemplary embodiments.

FIG. 5 is a view illustrating a structure of a cognitive assistance system, according to an exemplary embodiment.

FIGS. 6A and 6B are views illustrating a cognitive assistance system providing cognitive assistance to build cognitive insights and/or cognitive intelligence, according to an exemplary embodiment.

FIGS. 7A and 7B are views illustrating a process of generating cognitive multimedia data, according to an exemplary embodiment.

FIGS. 8A and 8B are flow charts illustrating a computer-implemented method of providing cognitive assistance, according to an example embodiment.

FIG. 9 is a block diagram illustrating hardware components of a cognitive assistance apparatus, according to an exemplary embodiment.

FIG. 10 is a block diagram illustrating various components of a cognitive assistance system, according to an exemplary embodiment.

### DETAILED DESCRIPTION OF EXEMPLARY EMBODIMENTS

Exemplary embodiments will now be described in detail with reference to the accompanying drawings. Exemplary embodiments may be embodied in many different forms and should not be construed as being limited to the illustrative exemplary embodiments set forth herein. Rather, the exemplary embodiments are provided so that this disclosure will be thorough and complete, and will fully convey the illustrative concept to those skilled in the art. Also, well-known functions or constructions may be omitted to provide a clear and concise description of exemplary embodiments. The claims and their equivalents should be consulted to ascertain the true scope of an inventive concept.

The descriptions of the various exemplary embodiments have been presented for purposes of illustration, but are not intended to be exhaustive or limited to the embodiments disclosed. Further, each exemplary embodiment disclosed herein has been included to present one or more different features. However, all disclosed exemplary embodiments are designed to work together as part of a single larger system or method. This disclosure explicitly envisions compound exemplary embodiments that combine multiple previously-discussed features in different exemplary embodiments into a single system or method.

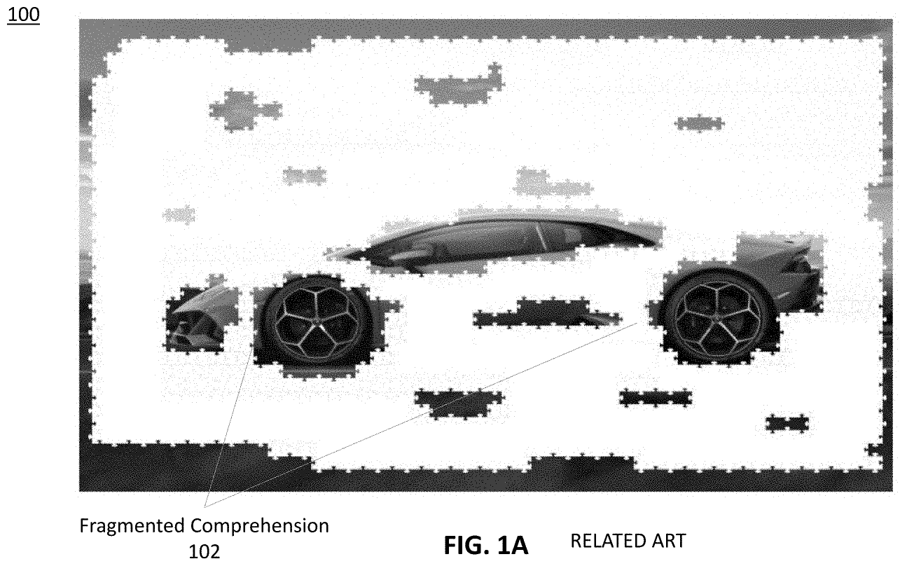

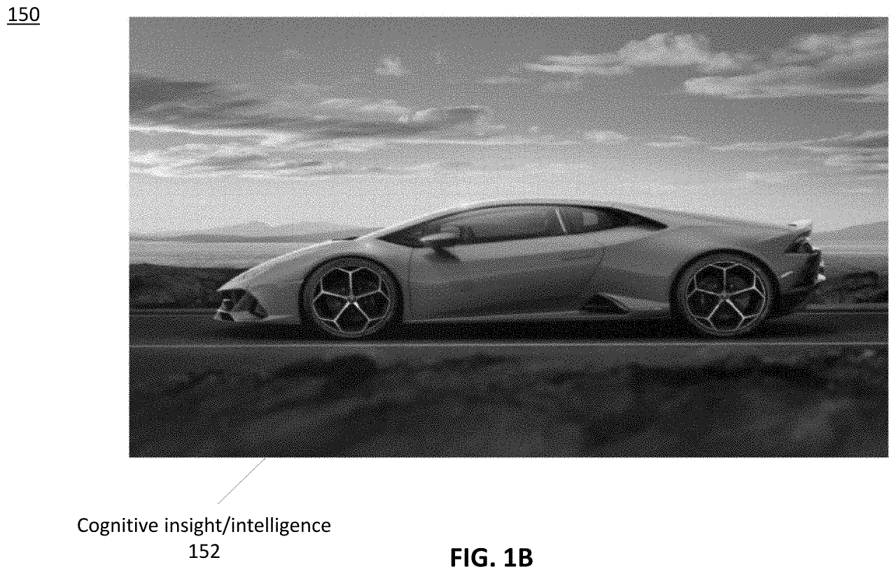

As noted above, traditional learning often results in a fragmented understanding. For example, FIG. 1A is a view 100 illustrating comprehension obtained, according to a traditional learning process. That is, existing digital learning environments are disconnected and are not mind-friendly, which may cause a learning overload and poor comprehension outcomes. To understand a topic (represented by a car in FIG. 1A), a user may study learning materials (such as textbooks, tutorials, user manuals, guides, etc.), attend a class (virtual, in person, etc.), and obtain additional tutoring in an attempt to master the topic. These various educational tools, however, are not connected to one another and are not cognitively structured to mimic a human brain. As such, only fragmented comprehension 102 of the topic may be obtained. Additionally, since only fragmented comprehension 102 is obtained, the memory retention of the topic may also be poor. It is not uncommon that students forget parts of a topic (before, during, or after a test).

There is a need for a cognitive platform that engages students in learning a concept(s), motivates students to learn concept(s) and associated skills, and provides cognitive insights that allow students to succeed in their future careers and lives outside of learning environment. There is a need for a cognitive-formatted platform that enables users to effectively develop and use higher-order thinking that is prerequisite to solving real-world problems and making better decisions. The users include teachers that provide the content and students that interact with the content to build cognitive insights and form cognitive intelligence.

Various information and/or content may be obtained from an environment of a user, downloaded from a network (data network), and/or generated by a user, see e.g., U.S. Pat. No. 10,367,931 to Nguyen, and U.S. Pat. No. 10,664,489 to Nguyen, incorporated herein by reference in their entireties for their helpful content. While exemplary embodiments describe information and/or content as being multimedia data, the inventive concept is not limited thereto and the information and/or content may be video, audio, text, images, and/or some combination of the foregoing. U.S. Pat. No. 11,120,705 to Nguyen is also incorporated herein by reference for its helpful content. This U.S. Pat. No. '705 provides various examples of forming comprehension guides.

The techniques described below provide a cognitive platform that processes various content from various sources (e.g., textbooks, lectures, tutorials, guides, etc.) to generate cognitive structure(s) that mimics brain's natural processes, thus helping the student to form cognitive insight (providing cognitive assistance) and cognitive intelligence.

FIG. 1B is a view 150 illustrating forming a cognitive insight 152 of a topic (represented by a car) using cognitive structure(s), according to an exemplary embodiment. Forming cognitive insight(s) further leads to memory retention of the topic and thus, may result in cognitive intelligence, as detailed below.

Briefly, the techniques presented below generate a unique cognitive platform that substantially enhances user's comprehension and helps build cognitive insights and form cognitive intelligence. It provides cognitive template(s) that integrate various materials (learning materials, concepts, guides, homework, etc.,) and links them together to “create the full picture”—the cognitive insight 152 thus, forming cognitive intelligence. The cognitive platform is structured to mimic learning performed by a human mind.

In one or more example embodiments, a cognitive assistance system has a cognitive platform and/or a cognitive framework to provide cognitive learning assistance. The cognitive assistance system is modeled based on how a human memory forms thoughts and memories i.e., thinking and learning.

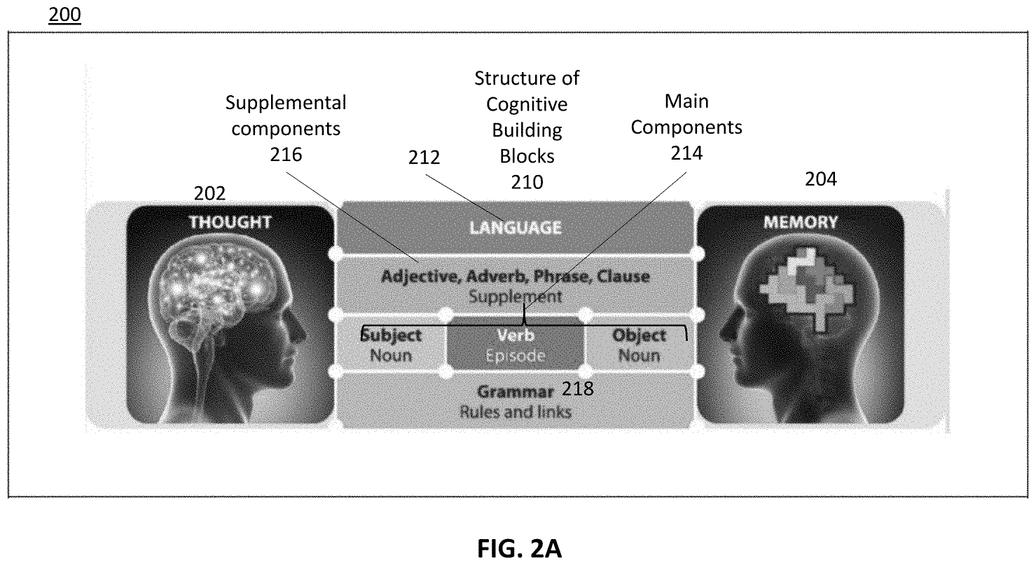

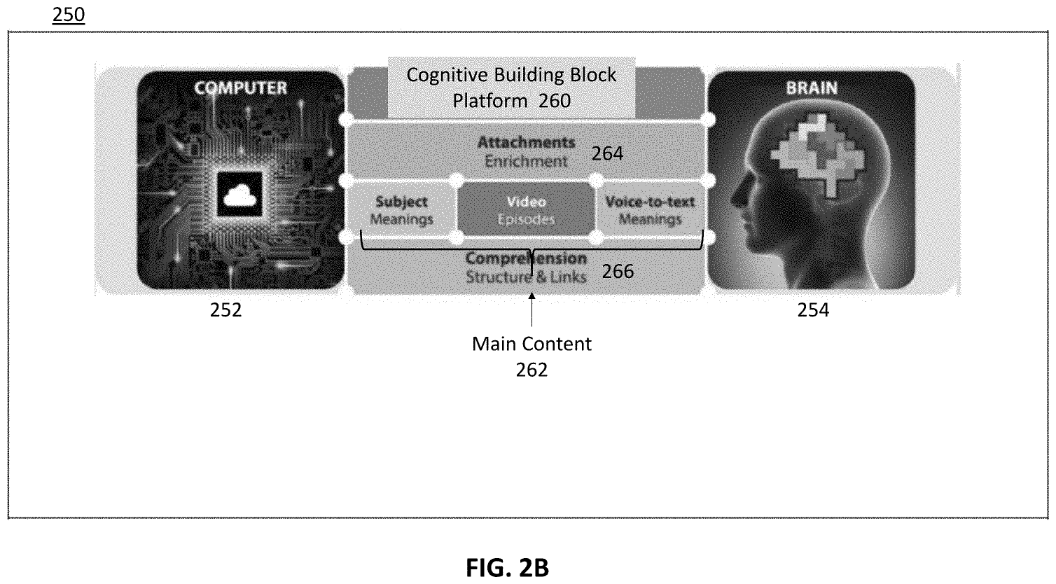

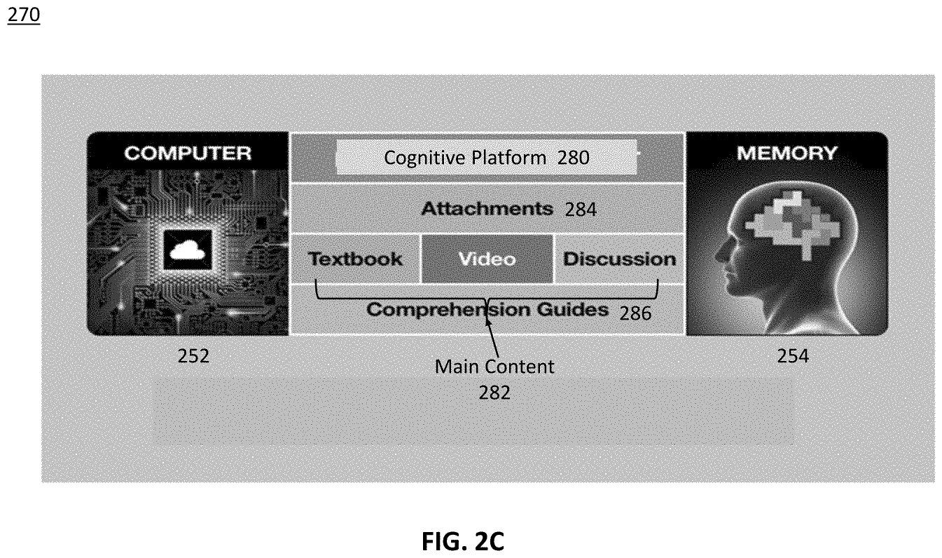

FIG. 2A is a view 200 illustrating a structure of cognitive building blocks 210 that mimic the structure of language 212, thoughts 202, and memories 204 in a human mind. The language 212 may involve main components 214, supplemental components 216, and grammar 218. The main component 214 includes subject, verb, and object. The supplemental component 216 includes additional elements such as adjectives, adverbs, phrases, clauses that explain and supplement the main component. Grammar 218 are rules and links that help piece together the elements of the main components 214 and supplemental components 216 into one complete sentence to form a complete thought as well as memory.

FIG. 2B is a view 250 illustrating a cognitive building block platform 260 that mimic the structure of cognitive blocks in the human brain in FIG. 2A for providing cognitive assistance, according to an exemplary embodiment. With the same structure or format, the cognitive building block platform 260 (cognitive platform) provides a bridge between a computer 252 and a human brain or memory 254. In other words, the cognitive building block platform 260, which is empowered by computer 252, is configured to generate a cognitive template that leads a human brain or memory 254 to an enhanced understanding and topic mastery.

In one or more exemplary embodiments, the users include a presenter and a learner. A presenter is a user that provides the content to be studied such as a teacher, a lecturer, a professor, an instructor, etc. A learner is a user that studies the content and the one that is to master the content such as a student, a pupil, etc.

The cognitive building block platform 260, which mimics the structure of language, thought, and memory involves a plurality of building blocks for structuring main content 262, supplemental content 264, and comprehension guide 266.

One of the purposes of a cognitive building block platform 260 is to help users understand a complex topic as simple as a complete sentence. The main content 262, which is similar to 214 in FIG. 2A, may involve multimedia content such a video of a lecture being presented by a presenter or a teacher. For the main content 262, subjects, learning objectives, semantic meanings are generated by the cognitive platform 260. The supplemental content 264, which is similar to 216 in FIG. 2A, may involve textbooks, study guides, tutorials, homework, assignments, or other study materials to help understand the main content. The comprehension guide 266, which is similar to 218 in FIG. 2A, includes various mappings such as chapters, subchapters, etc. for the main content. The comprehension guide 266 further includes various links between portions of the main content 262 and supplemental content 264, as detailed below. This is but one non-limiting example of the cognitive building block platform 260.

FIG. 2C is a view 270 illustrating a cognitive platform 280 for providing cognitive assistance, according to another exemplary embodiment. The cognitive platform 280 is a cognitive building block platform that also provides a bridge between the computer 252 and a memory 254 of a user such as a student. The cognitive platform 280, which is empowered by the computer 252, works in harmony with a human mind, i.e., the memory 254.

The cognitive platform 280 involves main content, which is similar to 214 in FIG. 2A, such as a video, a textbook, and class and/or online discussion of the subject being studied. The cognitive platform 280 further involves attachments 284, which is similar to 216 in FIG. 2A, and is supplemental content such as assignments, homework, experiences, links to additional material, etc., that is needed to obtain mastery of a subject or a concept. The cognitive platform 280 further involves comprehension guides 286, which is similar to 218 in FIG. 2A, and provide a map of the main content 282 such as chapters, subchapters, etc. Additionally, the comprehension guides 286 include links between various portions of the main content 282 and the attachments 284. For example, a homework assignment maybe linked to one of the chapters and/or subchapters of the main content 282, etc.

The cognitive platforms 260 and 280 are configured to generate a cognitive template for building insights and mastery of a subject. The cognitive platforms 260 and 280 generate various cognitive links using main content, supplemental content, and comprehension guides. Specifically, the cognitive platforms 260 and 280 help generate “scaffolding” links (L3) that commit content to a long term memory. The links include but are not limited to 1) “to be” links (L1), 2) “comprehension links” (L2), and 3) the “scaffolding” links (L3).

“To Be” Link (L1) are links that provide learning without context. These L1 links are between Meaning and Meaning within working memory without reference to the context in the long-term memory. In one example, L1 is explanation and definition word by word or sentence to sentence. The L1 links helps users study a meaning through another meaning. L1 links type of learning is usually associated with “To-the-Test” or “Cram-Learning.” This type of learning can fail to meet the conditions for comprehension and application.

“Comprehension” Link (L2) are links that provide learning with context. These L2 links are between meaning and its context. These L2 links bring contextual understanding to learning or “learning comprehension”. L2 link type contextual learning provides users with improved memorization of what is being studied. For example, L2 link is semantic to episodic of voice-to-text to video, or the link of the attachments to video that is created by the computer and the input of a user. However, in real-life, L2 links are most effective when the learning episodes are repeated or practiced. When L2 link type contextual learning is linked to other episodes in one's real-life, L3 learning starts to occur.

“Scaffolding” Link (L3) are links that bridge learning to real life experiences and help form mastery of the subject or a concept. These L3 links are between multiple episodes in the episodic memory. The L3 links increase comprehension to a higher level, generating mastery of concepts via cognition and forming “cognitive intelligence”. L3 links type of learning thru mastery relies on links similar to those between segments of a scaffolding system or links between episodes over a person's lifetime. Thus, these L3 links are “scaffolding links,” and this type of learning is learning to life. For example, L3 link is episodic-episodic between chapter-chapter in comprehension guides and/or the link between video type A—type A, type A—type B, as well as type B—type B on an Episodic Core Scaffolding, where type A is main content and type B is supplemental content. L3 type links are created by the computer and the input of the user.

The cognitive platforms 260 and 280 are configured to form L3 type links. The cognitive platforms 260 and 280 are a building block structure or a cognitive template that works compatibly with a computing device or a computer and a human brain, mimicking a building block structure of the language and human memory.

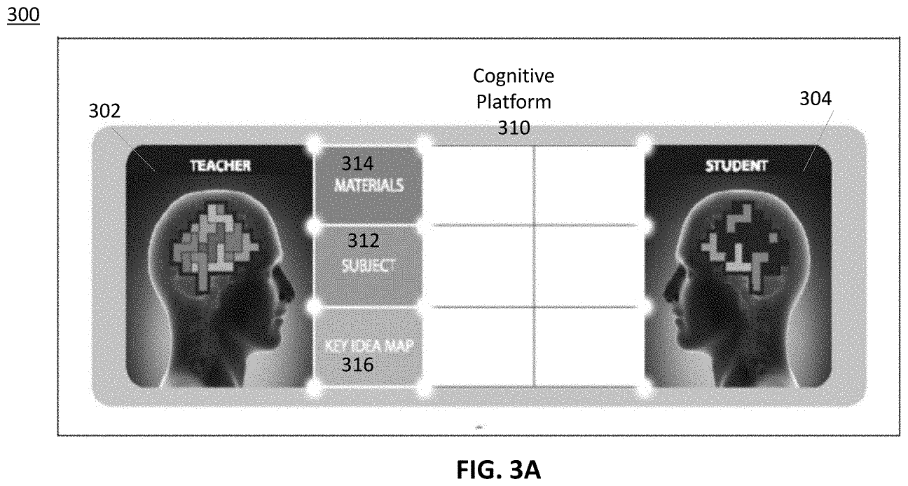

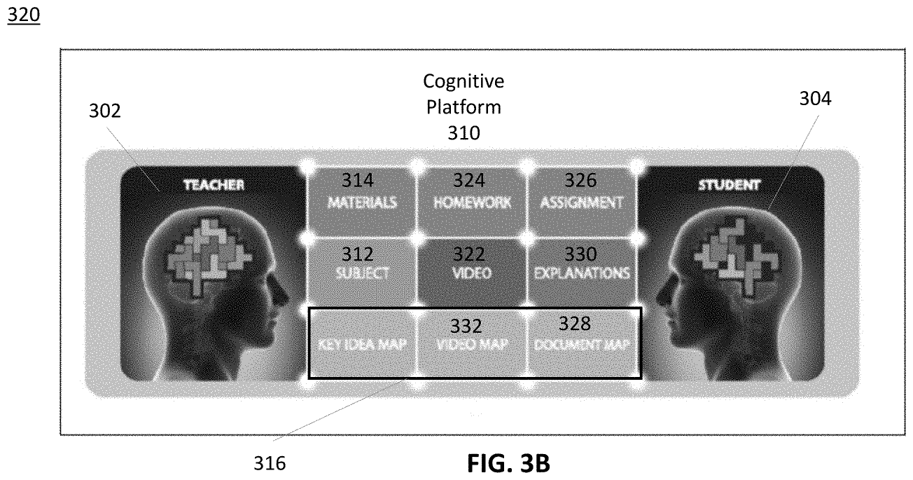

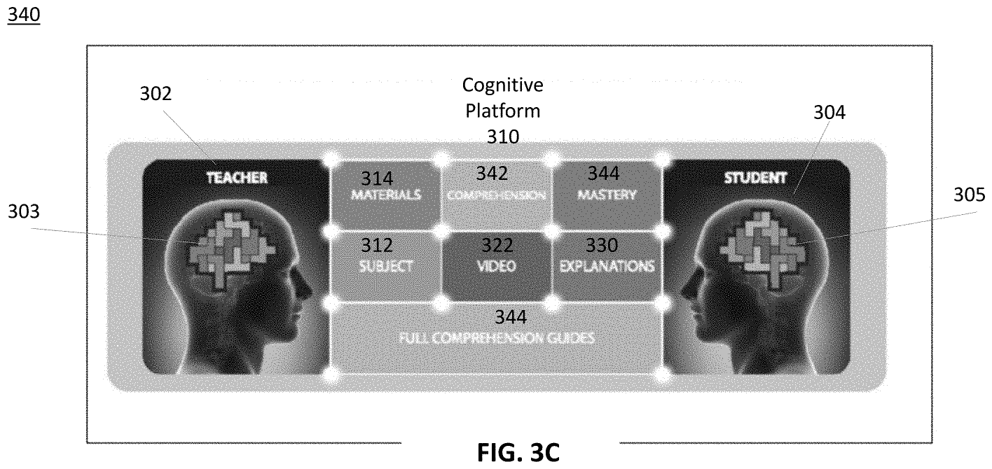

FIGS. 3A-3C are views illustrating user interactions with a cognitive platform 310 providing building block processes that lead to a user's comprehension and mastery of content, according to various exemplary embodiments. The cognitive platform 310 generates a cognitive template having a plurality of building blocks that form a comprehension canvas. In one non-limiting example, the comprehension canvas includes nine blocks.

While exemplary embodiments described herein are in the context of a student and a teacher, the cognitive platform is not limited thereto. The cognitive platform maybe used by two users for collaborations such as two workers, two professors, two students, etc. that share information with one another for comprehension and mastery of a core concept or a joint project, for example.

Specifically, FIG. 3A is a view 300 illustrating the cognitive platform 310 generating various links for the primary content, according to an exemplary embodiment. The cognitive platform 310 is a structure of cognitive building blocks or a cognitive building block platform. The view 300 involves a teacher 302 interacting with the cognitive platform 310 to teach (transfer his or her knowledge in a brain or memory 303 to) another user i.e., a student 304. In the view 300, the teacher 302 uses the cognitive platform 310 to prepare for a lesson, a presentation, and/or a lecture. That is, the teacher 302 shares materials for preview and preparation of a lesson for another user such as student 304. The cognitive platform 310 is a computerized cognitive assistance system, as explained in further detail below.

In the view 300, three cognitive building blocks are being formed, according to an exemplary embodiment. Specifically, the teacher 302 may input the subject of the lesson. The subject is a core concept, a main idea, or a topic of a lesson such as trigonometry lesson 1, introduction to algebra, beginning of the American Civil War of 1861, negotiation strategies in a crisis, etc. The cognitive platform 310 generates a first block 312 and adds the subject therein.

The teacher 302 may further input background material or content associated with the subject (materials) in the first block 312. The background materials may include textbook pages, guides, website links to definition, previews, etc. The cognitive platform 310 generates a second block 314 and input the materials therein.

Next, the teacher 302 generates headings, subheadings, etc. for the lesson and may input titles for each. In one exemplary embodiment, the cognitive platform 310 may suggest chapters (how to divide the content) and titles (names for the portion of the content) based on the input background material. When sections including heading, subheadings, and respective titles are input, a comprehension guide or a key idea map is generated. The key idea map forms the learning objectives (LOs) of the subject. The cognitive platform 310 generates a third block 316 with key idea map or LOs therein. Based on user input, various portions of the materials are linked to various learning objectives (e.g., chapters, sub-chapters, etc.) using links. The cognitive platform 310 generates links between the subject in the first block 312, various portions of the materials in the second block 314, and various learning objectives (LOs) in the key idea map in the third block 316. Moreover, the cognitive platform 310 adds links between various portions to the third block 316. Using the cognitive platform 310, the teacher 302 inputs a lesson plan and background material, for example, before the live lecture or before presenting the subject (core concept).

FIG. 3B is a view 320 illustrating the cognitive platform 310 generating various content to form cognitive insights and intelligence, according to an exemplary embodiment. In the view 320, the teacher 302 inputs content such as live video lessons, homework, and additional content.

Specifically, the teacher 302 may input a lesson in a form of a video where the main idea or core concept (the subject in the first block 312) is explained. The cognitive platform 310 generates a fourth block 322 and adds the video lesson therein.

The teacher 302 may further input homework associated with various portions of the video lesson in the fourth block 322. The homework may include questions (multiple choice or essay type answers) for the student 304 to complete and/or problems to solve. The cognitive platform 310 generates a fifth block 324 and input the homework therein. The teacher 302 may add additional material (assignment) such as tests, quizzes, real-world examples, etc. and generate a sixth block 326. The cognitive platform 310 generates links between various homework and assignment in the fifth block 324 and the sixth block 326, respectively, and inputs the links into the third block 316, for example as a document map 328.

The cognitive platform 310 may further generate semantic meaning of the video lesson stored in the fourth block 322. The semantic meaning may involve speech-to-text conversion (text transcript) of the video lesson. The cognitive platform 310 generates a seventh block 330 and inputs the semantic meaning therein. The semantic meaning in the seventh block 330 is synchronized with the video in the fourth block 322 using a video map 332. That is, the cognitive platform 310 generates links between the video stored in the fourth block 322 and explanations stored in the seventh block and forms the video map 332 that includes these links. The video map 332 may further include chapters, sub-chapters, etc. for the video lesson stored in the fourth block 322. The video map 332 is stored in the third block 316 along with the key idea map and the document map 328. That is, the third block 316 includes a plurality of links between various portions of the primary content, background content (materials), and various portions of the supplemental content (explanations, homework, and/or assignment) as well as a map with chapters, subchapters, etc.

In one example, based on input from the teacher 302, various portions of the material are linked to various LOs (e.g., chapters, sub-chapters, etc.) using links.

FIG. 3C is a view 340 illustrating interactions with the cognitive platform 310 to form cognitive insights and cognitive intelligence, according to an exemplary embodiment. In the view 340, the student 304 interacts with the cognitive platform 310 to form cognitive insights (comprehension 342) and cognitive intelligence (mastery 344) of the core concept (e.g., the subject stored in the first block 312).

For example, by completing one or more homework, stored in the fifth block 324, the student 304 forms cognitive insights (comprehension 342). That is, a portion of the core concept (the subject stored in the first block 312) is learned. As the student 304 continues to work with the content e.g., by completing the assignment stored in the sixth block 326, mastery 344 of the core concept is acquired. By comparison, homework stored in the fifth block 324 are specific tasks to help comprehend and commit, to a long term memory 305, a portion or a fragment of the content. Assignment stored in the sixth block 326, on the other hand, deal with multiple various portions or fragments of the content and include applications/real-life experiences of the core concept/subject. Thus, assignment help build mastery 344 of the core concept (the full picture) for a user (the student 304).

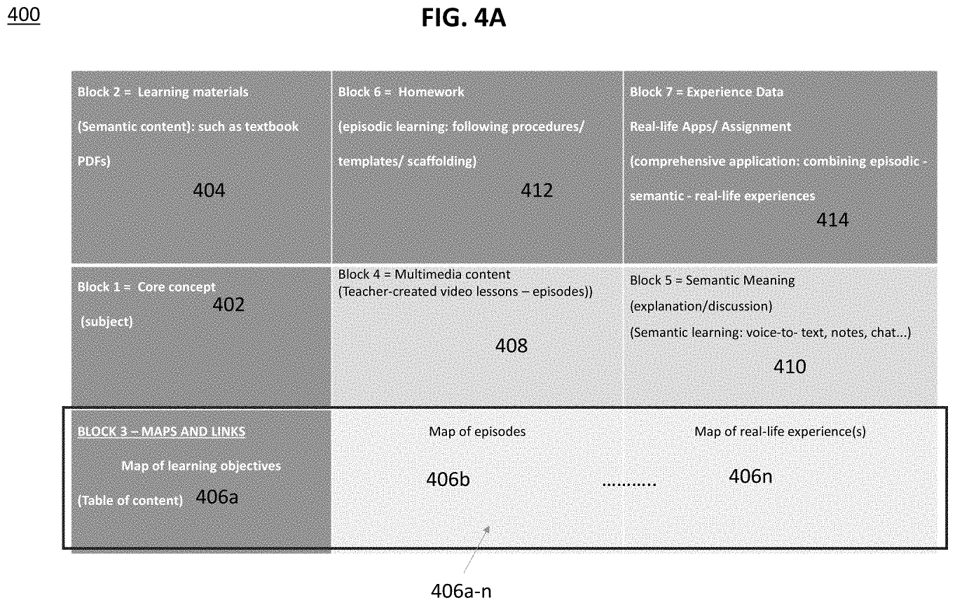

FIGS. 4A and 4B are views illustrating various cognitive building blocks, according to various exemplary embodiments. A cognitive assistance system, which includes the cognitive building block platform, generates various building blocks for a subject to be studied (core concept), according to one or more exemplary embodiments.

In FIG. 4A, the view 400 illustrating a plurality of cognitive building blocks, according to an exemplary embodiment. The view 400 includes a first building block which stores the core concept 402 (the subject to be studied). The core concept 402 may be a subject or a topic such as Algebra, Trigonometry, Civil War, a literary work, etc.

The view 400 further includes a second block which stores learning materials 404. The learning materials 404 are semantic content such as a textbook, a study guide, a workbook, an explanation, a laboratory procedure, rules, etc. These learning materials 404 may be provided in a form of a .pdf document(s), for example.

The view 400 further includes a third building block which stores various comprehension guides and a plurality of links. In this example, the third building block stores a map of learning objectives (LOs) 406a, a map of episodes 406b, and a map of real-life experiences 406n. The notation “a-n” denotes that a number of maps and/or links is not limited and may depend on a particular implementation, core concept, and use case scenario. The map of LOs 406a is a table of content such as various chapters/sub chapters for the core concept. The LOs may be user-generated or teacher-defined.

The fourth building block stores multimedia content 408. The multimedia content 408 is the primary (main) content. In one example, the multimedia content 408 is the teacher-created video lesson(s). It may be a recording of the teacher presenting various portions of the core concept 402. The multimedia content 408 is episodic teaching. Specifically, the multimedia content 408 is divided into a plurality of episodes or smaller portions (chapters, sub-chapters, etc.). The cognitive assistance system further generates a map of the multimedia content i.e., map of episodes 406b. The map includes various chapters and sub-chapters chronologically organized and linked to one another using pointers for example.

The cognitive assistance system further generates semantic meaning 410 for the multimedia content 408. The semantic meaning 410 (explanation, discussion, etc.) are stored in the fifth building block. The semantic meaning 410 includes voice-to-text conversion of the main content (multimedia content 408), and may further include notes made by a student or a teacher, explanation of the teacher, discussion between various users during a lesson, etc.

The cognitive assistance system divides the multimedia data into a plurality of episodic units or a plurality of cognitive resolution units (CRUs). The CRUs are equal in length and correspond to a specious present. The “specious present” or an interval of about three seconds that correspond to human's sense of nowness. In other words, this is a duration of a deliberate action such as a handshake or it is a duration of a line of poetry, or a duration of a musical motif such as opening notes of Beethoven's Fifth Symphony which a person does not hear as a single note followed by another note but rather as a union, a cohere, a gestalt, and in some sense, a motif is obtained. Content and/or information is processed to generate the cognitive elements each of which include the cotif and is also linked to a background required to understand the cotif. In other words, the CRU is an average time that a person speaks an average-length complete sentence at an average speed. The CRU may be determined from one second to five seconds. The CRU is determined based on the average time for transferring an episodic thought in the Broca's area of a human brain into a semantic block and expressing the episodic thought in a form of language as a complete sentence e.g., a sentence with subject, verb, and object such as a duration of a line of a poetry. The CRU is 2.16 seconds or 2 seconds, for example. Each CRU may be of same length. In short, the multimedia content 408 is divided into video episodes or CRUs.

The cognitive assistance system stamps a unique video identifier (ID) on each of the plurality of CRUs, group at least two consecutive CRUs into the respective cognitive block based on the first user input (forming a subchapter, chapter), and stamp a cognitive ID on the respective cognitive block.

The cognitive assistance system semantically analyzes the plurality of episodic units or CRUs to extract a semantic meaning 410 of each of the plurality of CRUs, convert the semantic meaning into a text, a sketch, a symbol, or an image to represent a cue for a respective CRU, and generate a plurality of semantic units that respectively correspond to the plurality of CRUs and further comprise the cue. The semantic meaning 410 is stored in the fifth building block and is synchronized with episodes of the multimedia content 408 using links stored in the third building block.

The cognitive assistance system further obtains homework 412. Homework 412 includes tasks that require user involvement such as the student. For example, homework 412 requires review and/or input from the student. The homework 412 includes episodic learning such as following a certain procedure(s), filling in or responding to templates, and/or scaffolding. The homework 412 is linked by the teacher with one or more episodes of the multimedia content 408. The homework 412 is stored in the sixth building block. The cognitive assistance system adds one or more links to connect task(s) in the homework 412 with one or more episodes of the multimedia content 408. The links are stored in the third building block. By (correctly) completing the tasks and working through the tasks in the homework 412, the user (student) forms cognitive insights (comprehension of one or more fragments of the core concept 402).

The cognitive assistance system further obtains experience data 414. Experience data 414 includes real-life application of the learned concept. For example, it may combine materials learned in various episodes and provides assignments that require applying the material or having a real-life experiences. By interacting with assignments in the experience data 414 or by having real-life experiences, the user gains mastery of the core concept 402 i.e., forms cognitive intelligence. The cognitive assistance system generates a map of real-life experience(s) 406n and stores it in the third building block. The map of real-life experience(s) 406n, links various assignments or real-life application to various multiple episodes of the multimedia content 408.

With continued reference to FIG. 4A, FIG. 4B is a view 450 illustrating a formation of a cognitive-intelligence block, according to an exemplary embodiment. The view 450 illustrates that by completing homework 412, the user forms comprehension 452. In other words, the user develops cognitive insight by completing the homework 412. When the user is able to apply the content learned, experience data 414 is generated and expertise 454 or mastery is formed. The expertise 454 is the cognitive intelligence being generated such as comprehending the core concept 402 e.g., the entire car of FIG. 1B. The completed building blocks in the view 450 result in generating a cognitive intelligence block 456. The cognitive intelligence block 456 includes a plurality of building blocks (building blocks 1-7).

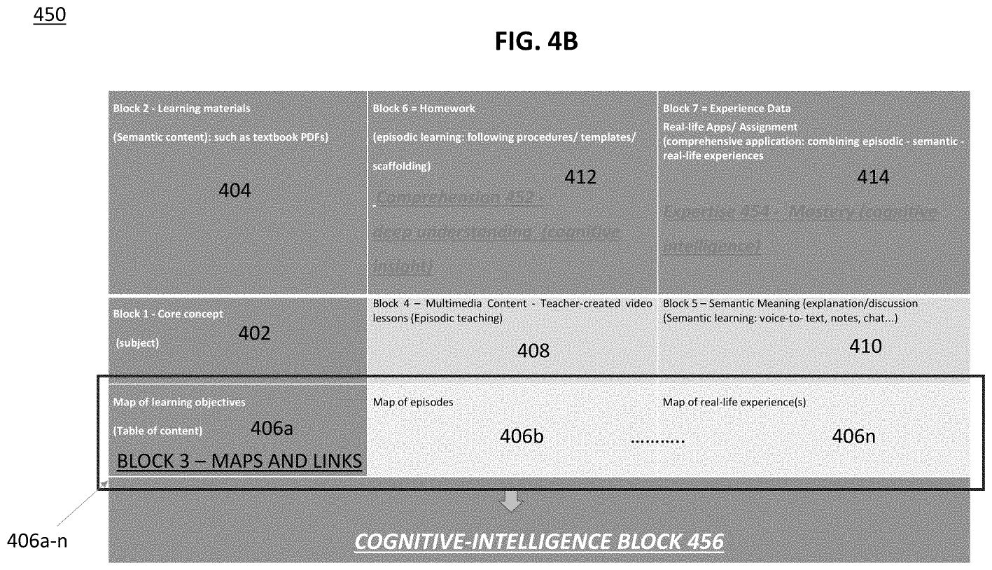

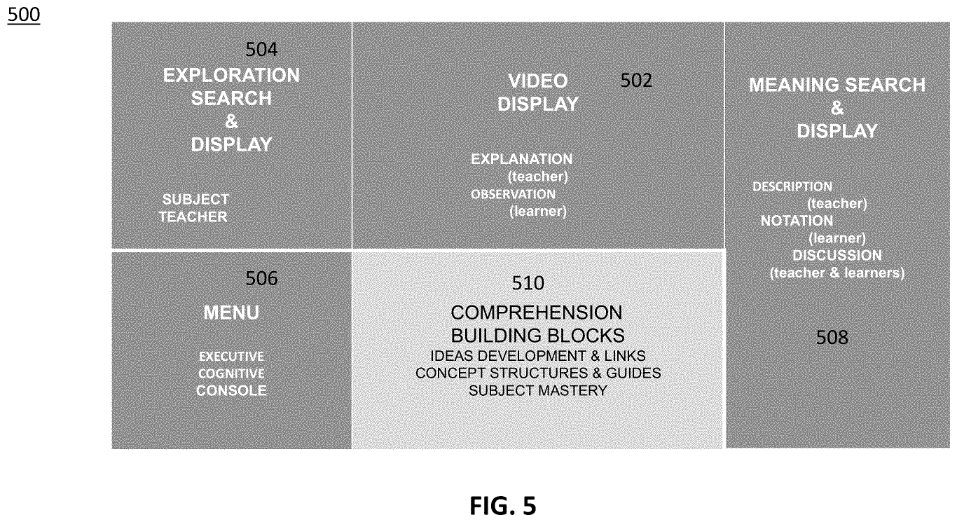

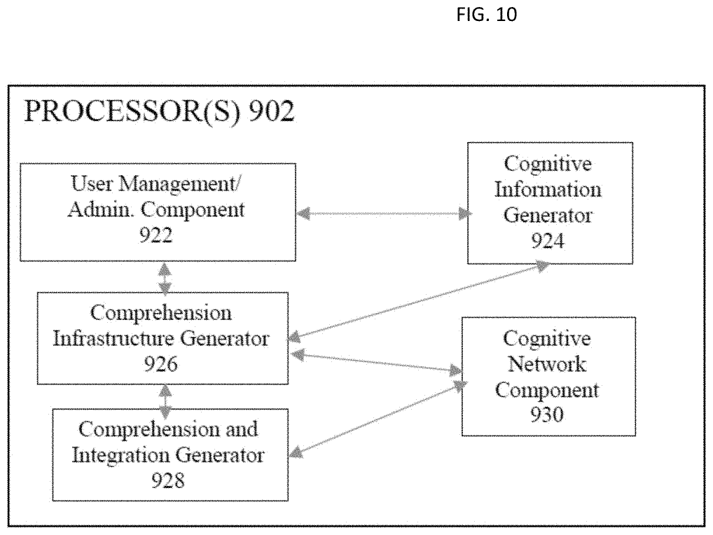

FIG. 5 is a view illustrating a structure of a cognitive assistance system 500, according to an exemplary embodiment. This particular implementation is provided by way of an example only and not by way of a limitation. The cognitive assistance system 500 includes various components and uses the cognitive platform such as the cognitive platform 260 of FIG. 2B, the cognitive platform 280 of FIG. 2C, or the cognitive platform 310 of FIGS. 3A-3C. The cognitive assistance system 500 includes various components that are executed by a processor or processor(s) of one or more computing device and/or by one or more servers, as explained by way of an example with reference to FIG. 10.

The cognitive assistance system 500 includes an interface with various display areas such as a video display 502, exploration search 504, menu interface 506, meaning search 508, and comprehension building blocks 510. This is but one non-limiting example.

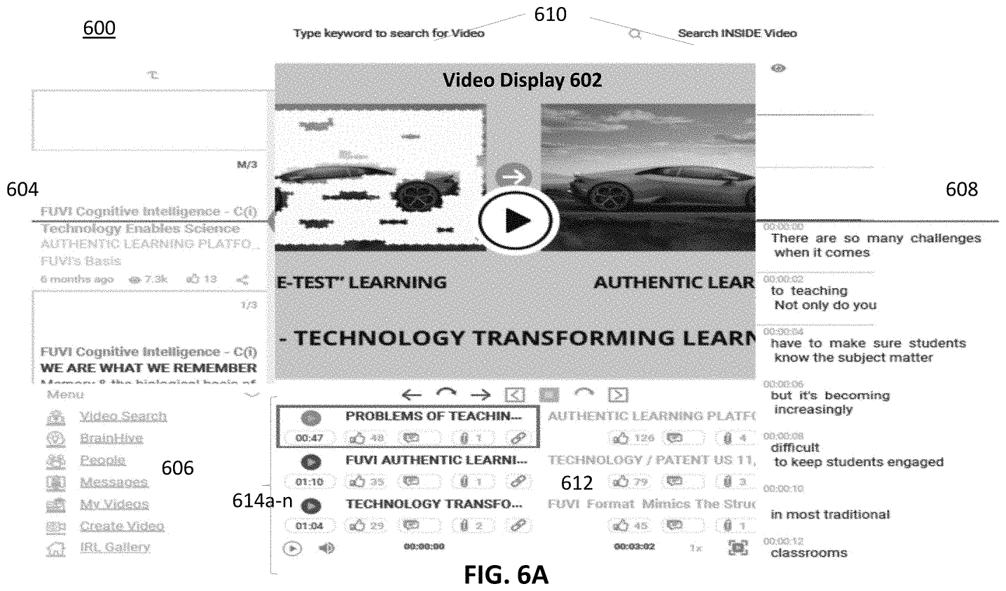

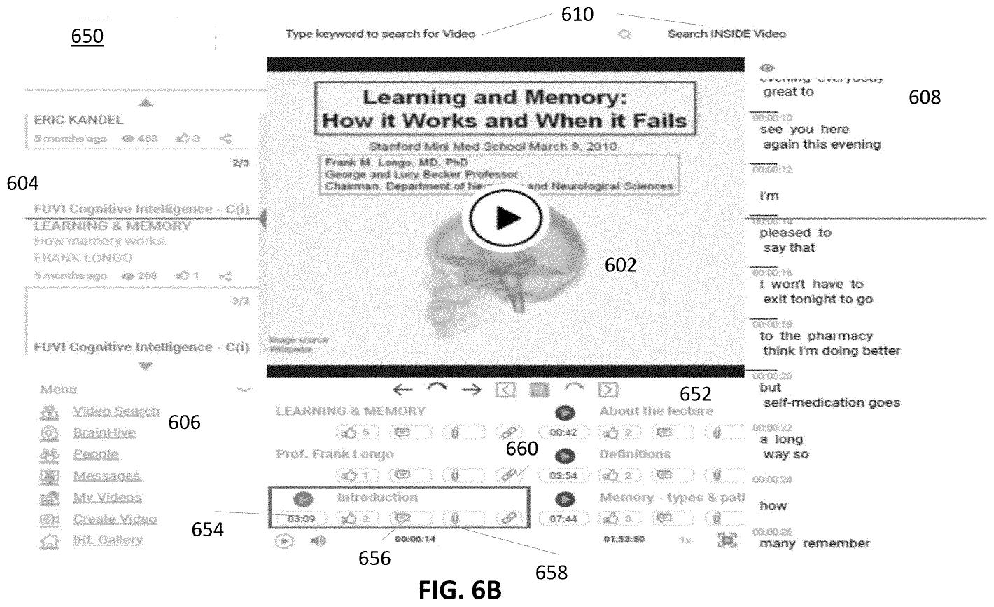

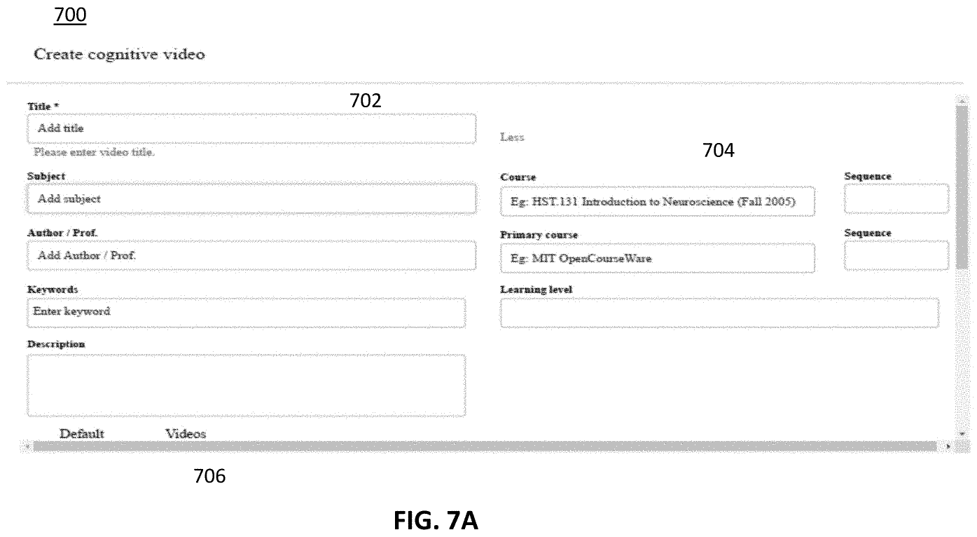

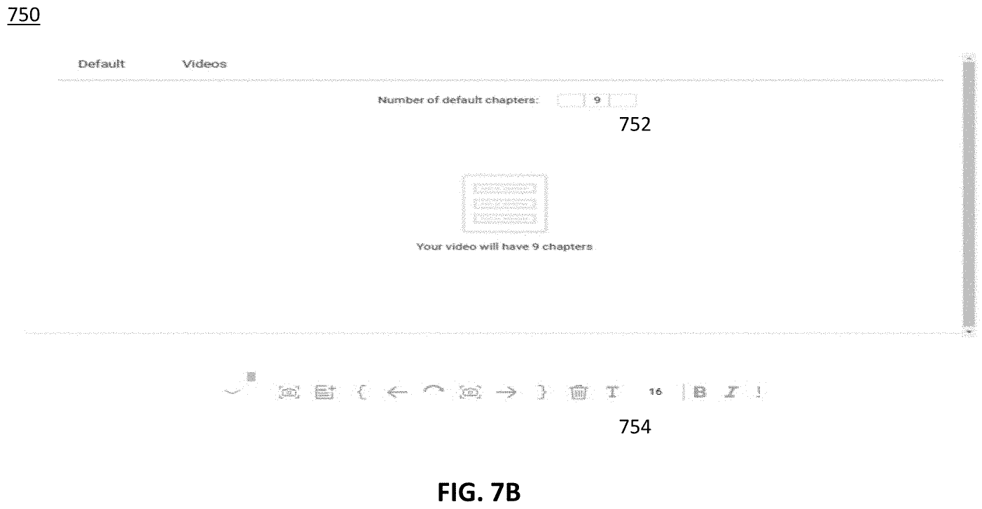

The video display 502 is a display area configured to provide various content to the user, as explained with reference to FIGS. 6A-7B, according to various exemplary embodiments. For example, based on user input, multimedia content 408 of FIGS. 4A and 4B may be provided to the user. Based on the user input, the video display 502 may display a corresponding portion of the learning material 404 of FIGS. 4A and 4B, homework 412, and/or experience data 414 of FIGS. 4A and 4B.

The exploration search 504 is a display area that provides for searching for a subject based on subject name, based on a teacher name, etc. By navigating the exploration search 504, the user selects a core concept 402 of FIGS. 4A and 4B.

Menu interface 506 is a user interface for searching and selecting various content. The menu interface 506 may include but is not limited to performing video searching, people searching, creating lessons and videos, messaging functionality, image/picture gallery with secondary content, etc. The menu interface 506 is a main menu for various functionalities.

The meaning searching 508 is a user interface for searching based on semantics. For example, the user may type in a keyword and obtain portions of the video (main content—episodic units) and semantic units that include the keyword. Using the meaning searching 508, the user may search inside the multimedia content such as a video.

The cognitive assistance system 500 further includes the cognitive platform such as the cognitive building block platform 260 of FIG. 2B, the cognitive platform 280 of FIG. 2C, or the cognitive platform 310 of FIGS. 3A-3C. The cognitive platform, which includes the comprehension building blocks 510, is a cognitive template that structures the content (primary, secondary, homework, assignment, etc.) in a form that facilitates forming cognitive insights and/or mastery. The comprehension building blocks include links, maps, concept structures, and various comprehension guides to assist the user in obtaining subject mastery.

FIGS. 6A and 6B are views 600 and 650, respectively, illustrating a cognitive assistance system 500 providing cognitive assistance to build cognitive insights and/or cognitive intelligence, according to various exemplary embodiments.

The view 600 includes video display 602 for playing the main/primary content. The view 600 further includes the display of the core concept 604, which is the topic or subject being studied. The main menu 606, provides various functionalities of the cognitive assistance system 500 including searching and selecting videos, notes/discussions (brain hive), people. It further includes messaging functionality and generating videos (creating new lessons by the teachers). Additionally, secondary content such as a video B or a photo, image, etc. may be selected in the TRL gallery.

The view 600 further includes semantic meaning 608 of the multimedia content displayed in the video display 602. That is, as the user views the multimedia content in the video display 602, a corresponding semantic meaning 608 is provided. The episodic units of the multimedia content are synchronized with the semantic units.

Additional keyword searching tools 610 are provided such that the user may search for videos that include the input keyword and/or may search inside the current video being played.

The view 600 further includes various comprehension guides 612. The comprehension guides 612 split the multimedia content into a user-defined parts 614a-n. The user-defined parts 614a-n may further be split into various subparts. An example of a user-defined part is a title of a chapter. Each user defined part may include one or more attachments such as an attachment (link) to a corresponding portion of the learning material (e.g., textbook), a corresponding homework, and/or a corresponding real-life experience. Also, a number of attachments and types of attachments is displayed in the comprehension guides 612. The comprehension guides 612 are generated based on the maps and links stored in the third building block of FIGS. 4A and 4B.

With continued reference to FIG. 6A, FIG. 6B is a view 650 illustrating a comprehension guide 652 according to an exemplary embodiment. In this comprehension guide 652, size 654 of a user-defined part is provided, discussions and/or notes 656, corresponding attachments 658 such as homework, assignments, real-life experiences, practical applications, etc. and links 660 to other related episodic units, learning material, etc.

In one or more example embodiments, the user easily toggles between the main content (multimedia content) and learning material (textbook) such that corresponding portions of the textbook are displayed instead of the multimedia content in the video display 602.

FIGS. 7A and 7B are views 700, 750 illustrating a process of generating cognitive multimedia data, according to an exemplary embodiment. In one example, by selecting to create a video in the main menu 606 of FIGS. 6A and 6B, the user is provided with the view 700. The view 700 is provided for the user to generate a lesson plan. The cognitive assistance system 500 is configured to generate a lesson plan of the user in a cognitive format.

In the view 700, the user may input general information 702 about the core concept or a subject of his lesson and background information 704 such as requirements and pre-requisites for the core concept. The user may further input various multimedia data 706.

The cognitive assistance system 500 of FIG. 5 is configured to provide the view 750 for each multimedia data 706 input by the user. Specifically, the user may generate a number of user-defined units 752, the user may then adjust user-defined units such that some are longer and some are shorter using tools 754. The user may further title each unit using the tools 754 and/or a default title may be suggested by the cognitive assistance system. Additionally, using the tools 754, the user may attach to one or more user-defined units, corresponding learning material, homework, and/or assignments.

Referring back to FIGS. 6A-6B, comprehension guide(s) are generated based on user input, as explained with reference to FIGS. 7A and 7B. The comprehension guide(s) serve as cognitive templates that have one or more cognitive building blocks. In one example, some of the building blocks are initially empty or blank. These blocks are developed during the process of creativity i.e., when the user generates a lesson as shown in FIGS. 7A and 7B. As another example, some chapter boxes in the comprehension guide may be empty. They may be chapter heading containing only titles and attachments without videos. Videos may be added during working process.

The cognitive assistance system 500 of FIG. 5 is further configured to obtain input from multiple users such as a teacher and students. Both the teacher and their students together enrich and complete the comprehension canvas, according to an example embodiment. The student reviews lesson, does homework, inputs their learning (data of their learning processes, such as questions, work on a comprehension board (doing homework/assignment), homework/assignment submission, research, and so on. The teacher input the answers, explanations, homework correction/assignment comment, and so on. All of these various data is linked using maps and links in the third building block. For example, homework completed correctly becomes a cognitive insight (comprehension) and assignment completed correctly becomes cognitive intelligence (mastery).

In various example embodiments, machine learning (ML) and artificial intelligence (AI) are provided to allocate videos of a content B type and newly created video into the main scaffolding/main content (defining where in the scaffolding they are best to link to) during or after the presentation by the teacher.

In one example implementation, the cognitive assistance system 500 generates nine building blocks of the canvas and stamps them with respective identifiers (building block 1-9). This is but one example, and the number of building blocks is 1-n depending on a particular use case scenario. In this example, block 1 includes materials such as a textbook pdf, block 2 includes a subject such as a video label, block 3 includes a table of topics such as a lesson plan including heading chapters, for example, part A—introduction, part B—how to solve the problem, part C—how to use it in real-life, block 4 includes a homework pdf attached, block 5 includes one or more uploaded video episodes, block 6 includes a video map including video chapters (video chapter labels a, b, c, d . . . see e.g., U.S. Pat. No. '705). Each chapter has a chapter label and links with a startpoint and an endpoint of an episode in the video. Block 7 includes an assignment pdf and block 8 includes an explanation including voice-to-text or further notes, comments synchronized with respective episodes in the video. Block 9 may include a document mapped on comprehension guides including links of attachments 1, 4, 7 and heading chapter 3, video chapter 6, by way of an example.

As another example, a content creator such as a teacher may rearrange the order of heading chapters A,B,C and video chapters a, b, c, d . . . to be a table of cognition or comprehension guides (see e.g., U.S. Pat. No. '705), such as:

part A

a, b, c, d

part B

e, f, g, h

part C

m, n, o, p

The users (students and teachers) may toggle between episodic unit (main content) and a corresponding portion of the learning material (such as textbook, etc.). That is, since episodic units, semantic units, and various portions of the background material are linked together and synchronized, the user may view a related corresponding portion of the textbook and then toggle back to the main content (a respective episodic block) and then toggle again to the corresponding portion of the background material, etc. That is, not only are the semantic units are synchronized with the episodic units but also the secondary content such as background material and supplemental material (homework, assignments, etc.).

Students complete the homework in block 4 and transfer the completed homework assignment into completed homework or comprehension. The students may attach those comprehension blocks directly into block 4. Students complete assignments in block 7 and transfer them into completed assignments or mastery blocks. Students may attach these mastery blocks to block 7.

The cognitive assistance system such as the cognitive assistance system 500 in FIG. 5, may determine whether cognitive insights are formed by examining state of completion and accuracy of the homework i.e., examine completed homework (acquired comprehension) stored in the building block 4 and determine mastery of the core concept based on completed assignments stored in block 7 (state of completion and accuracy). The cognitive assistance system may evaluate the state of completion (whether the homework and/or assignments are completed) and how correctly they are completed (e.g., percentage of correct answers). Based on quantity (completeness) and quality (correctly or wrong answers), the cognitive assistance system 500 may determine cognitive insights and cognitive intelligence (mastery) of the core concept. The cognitive assistance system may provide the user with an indicator of his mastery in a form of FIG. 1B, for example. As more and more cognitive insights are formed, the user views more and more of the car, eventually obtaining mastery of FIG. 1B.

While various exemplary cognitive building block platforms were presented above, it is understood that various components of these cognitive building block platforms may be combined and work together. That is, various exemplary embodiments or features of these exemplary embodiments may be combined to form a single embodiment. Further, the cognitive assistance system may select one of the building block platforms depending on the core concept and use case scenario.

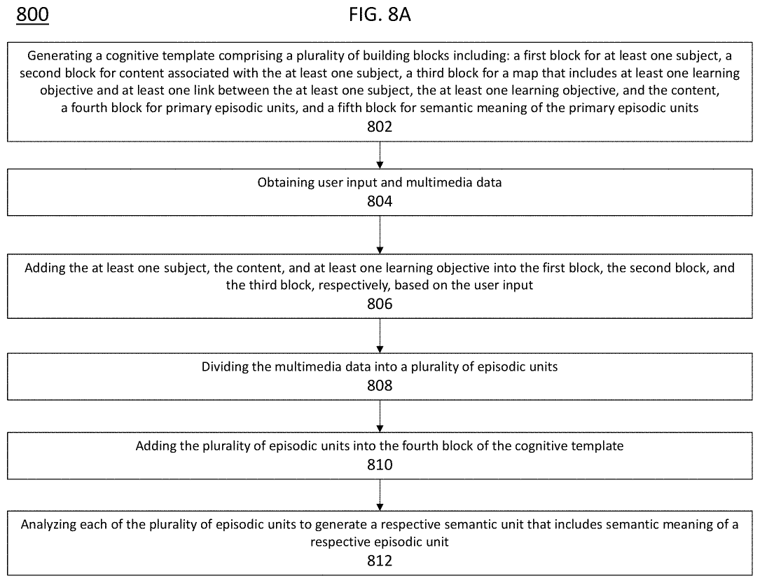

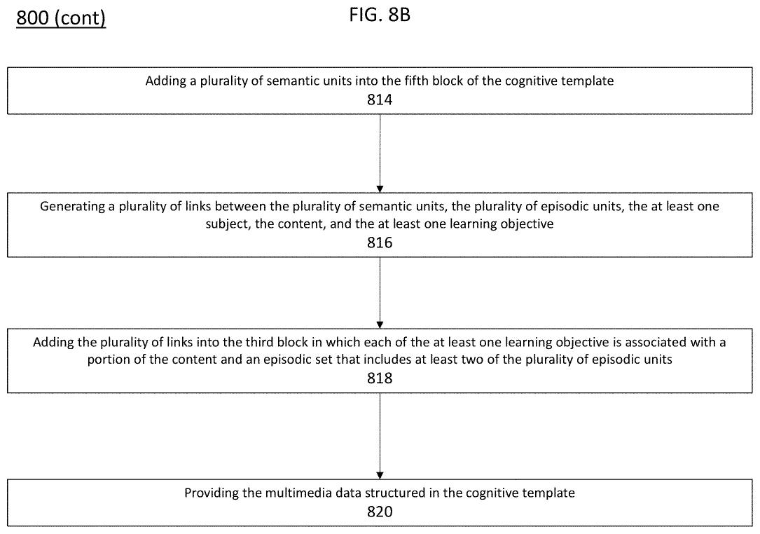

FIGS. 8A and 8B are flow charts illustrating a computer-implemented method 800 of providing cognitive assistance, according to an example embodiment.

In FIG. 8A, the method 800 involves at 802, generating a cognitive template. The cognitive template includes a plurality of building blocks including a first block for at least one subject, a second block for content associated with the at least one subject, a third block for a map that includes at least one learning objective and at least one link between the at least one subject, the at least one learning objective, and the content, a fourth block for primary episodic units, and a fifth block for semantic meaning of the primary episodic units.

The method 800 further involves at 804, obtaining user input and multimedia data and at 806, adding the at least one subject, the content, and at least one learning objective into the first block, the second block, and the third block, respectively, based on the user input.

The method 800 further includes at 808, dividing the multimedia data into a plurality of episodic units and at 810, adding the plurality of episodic units into the fourth block of the cognitive template.

The method 800 further involves at 812, analyzing each of the plurality of episodic units to generate a respective semantic unit that includes semantic meaning of a respective episodic unit.

With reference to FIG. 8B, FIG. 8B shows that the method 800 further involves at 814, adding a plurality of semantic units into the fifth block of the cognitive template and at 816, generating a plurality of links between the plurality of semantic units, the plurality of episodic units, the at least one subject, the content, and the at least one learning objective.

The method 800 further involves at 818, adding the plurality of links into the third block in which each of the at least one learning objective is associated with a portion of the content and an episodic set that includes at least two of the plurality of episodic units and at 820, providing the multimedia data structured in the cognitive template.

In one instance, the operation 820 of providing the multimedia data structured in the cognitive template may include obtaining additional user input and displaying the at least one subject in a main display area based on the user input.

In another instance, the operation 820 of providing the multimedia data structured in the cognitive template may include displaying the at least one learning objective in a display area and obtaining additional user input in which a learning object from among the at least one learning objective is selected. The operation 820 may further involve determining a respective episodic set and a corresponding semantic set that includes at least two of the plurality of semantic units that are associated with the learning objective based on the links in the third block and synchronously playing the respective episodic set and the corresponding set semantic set.

In yet another instance, the operation 820 of providing the multimedia data structured in the cognitive template may include toggling, based on additional user input, between the episodic set and the portion of the content associated with the episodic set. The episodic set and the portion of the content are both linked to the same learning objective from among the at least one learning objective based on the plurality of links in the third block.

In one or more exemplary embodiments, the method 800 may further involve obtaining secondary content related to the multimedia data, adding the secondary content to a sixth block of the cognitive template, and generating at least one content link that connects the secondary content to at least one of the plurality of episodic units, a corresponding learning objective, and a corresponding semantic unit. The method 800 may further involve adding the at least one content link to the third block of the cognitive template such that the secondary content is provided based on a selection when viewing the at least one of the plurality of episodic units.

In one instance, the method 800 may further involve toggling, based on additional user input, between the plurality of episodic units and the secondary content, linked to same one of the at least one learning objective.

In another instance, the method 800 may further involve obtaining additional user input with respect to the secondary content. The additional user input demonstrates a level of comprehension of the at least one subject. The method 800 may further involve adding the additional user input with the secondary content as a comprehension unit into a seventh block of the plurality of building blocks.

According to one or more exemplary embodiments, the secondary content may include at least one at least one of a task to be completed by a user. The user input may include an input of a content provider and the additional input is of the user.

According to one or more exemplary embodiments, the method 800 may further involve determining whether a cognitive insight is formed based on analyzing the plurality of building blocks in the cognitive template. For example, the seventh block is analyzed to determine user's comprehension of the learning objective.

In one instance, the method 800 may further involve obtaining experience data associated with a real-life problem related to the multimedia data and adding the experience data into an eight block of the plurality of building blocks. The method 800 may further involve generating at least one application link that connects the experience data to at least one of the plurality of episodic units, a corresponding learning objective, and a corresponding semantic unit and adding the at least one application link to the third block of the cognitive template. The experience data may be provided based on a selection when viewing the at least one of the plurality of episodic units.

According to one or more exemplary embodiments, the method 800 may further involve obtaining additional user input with respect to the real-life problem. The additional user input may relate to a personal experience of the user. The method 800 may further involve adding the additional user input together with the experience data that relates to a mastery by the user of the at least one subject into a ninth block of the plurality of building blocks and generating at least one mastery link that connects the additional user input together with the experience data to at least one of the plurality of episodic units, a corresponding learning objective, and a corresponding semantic unit. The method 800 may further involve adding the at least one mastery link to the third block of the cognitive template.

In one example, the method 800 may further involve determining whether the at least one subject is mastered by the user based on analyzing the plurality of building blocks in the cognitive template.

In another example, the method 800 may further involve determining whether the at least one subject is mastered by the user based on analyzing the ninth block.

In one form, the operation of determining whether the at least one subject is mastered by the user may include determining whether the mastery is formed based on analyzing a state of completion of the ninth block.

According to one or more example embodiments, the method 800 may further involve obtaining additional user input and displaying the content of the second block based on the additional user input. The content may be a tutorial or a textbook and the content in the second block may be linked with at least one episodic unit in the fourth block.

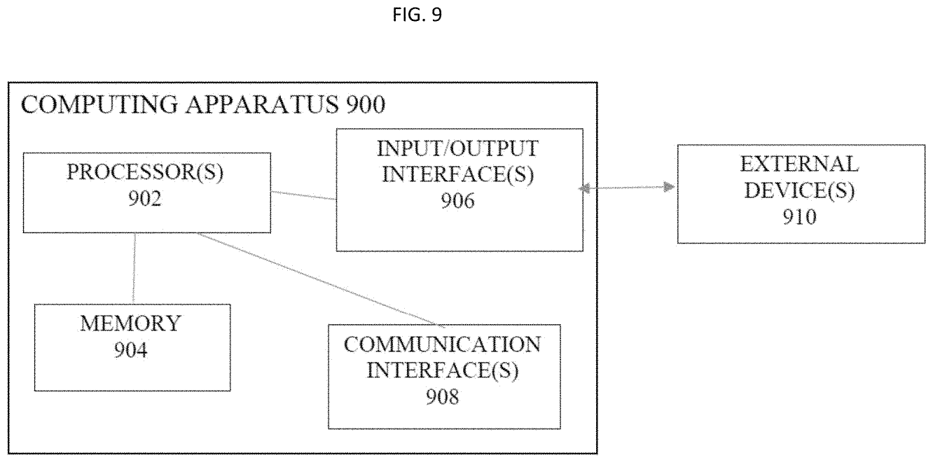

FIG. 9 is a block diagram illustrating hardware components of a cognitive assistance system such as the cognitive assistance system 500 of FIG. 5, according to an exemplary embodiment.

In FIG. 9, a cognitive apparatus (a computing apparatus 900) may be a server and/or include one or more computers. The apparatus 900 is a processing apparatus that includes one or more processors 902, which may be a central processing unit (CPU), which controls the apparatus and its hardware components and executes software instructions stored in one or more memories such as a memory 904. By way of an example, the one or more processors 902 may also include a random access memory (RAM), a read only memory (ROM), one or more graphical processes, interfaces, and so on. Components of the one or more processors 902 may be connected to each other via a bus.

The processor 902 is further connected to input/output interfaces 906 that may connect the processor to one or more external device(s) 910 such as a display, which outputs recorded and/or original video signals in various forms and formats and displays the comprehension guides, and various comprehension integrated contents, timelines, platforms described with reference to FIGS. 4A-8B. The external device(s) includes a speaker, which outputs an audio sound. This is provided by way of an example and not by way of a limitation. Multiple speakers may be provided and maybe external to the display.

The one or more processors 902 may be connected to one or more communication interfaces 908 (a network interface or a network card) which may include a WiFi chip, a Bluetooth chip, wireless network chip, and so on. The one or more communication interfaces 908 may further include one or more ports for wired connections. Additionally, the computing apparatus 900 may include the memory 904, which may store one or more of executable instructions which when executed by the one or more processors 902 cause the processor to control the computing apparatus 900 and its components. The memory 904 may further store audio and video data (contents) and computer executable instructions to be executed by the processor to perform one or more of the operations set forth in FIGS. 2A-8B. The computing apparatus 900 may further include a user interface as one of the input/output interfaces 906, which may include buttons, keyboard, a mouse, a USB port, a microphone, a gesture sensor, and so on. The user interface receives user input in various formats such as gestures, audio via a microphone, keyboard, mouse, touch screen, and so on, provided by way of an example and not by way of a limitation.

The processors 902 may execute instructions stored in the memory 904. The instructions cause the processor 902 to perform the methods described above with reference to FIGS. 2A-8B. The instructions may further cause the processor 902 to obtain multimedia data and divide the multimedia data into episodic units. The instructions may further cause the processor 902 to stamp the plurality of consecutive episodic units with a corresponding identifiers and to divide, based on user input received via the input/output interfaces 906, the multimedia data into a plurality of user-defined parts (chapters/sub-chapters). The instructions may further cause the processor 902 assign a label (title) to each of the plurality of user-defined parts based on the user input and stamp each of the plurality of user-defined parts with a corresponding cognitive identifier. The instructions may further cause the processor 902 to control the display to display, based on the plurality of video IDs and the plurality of cognitive IDs, a comprehension guide comprising the label for each of the plurality of the user-defined parts while playing the plurality of episodic blocks. The instructions may further cause the processor 902 to toggle between displaying learning material and playing corresponding multimedia data based on user input.

FIG. 10 is a block diagram illustrating various components of a cognitive assistance system such as the cognitive assistance system 500 of FIG. 5, according to an exemplary embodiment. For example, the one or more processors 902 may execute the cognitive assistance system that includes various components such as a user management and administrative component 922, a cognitive information generator 924, a comprehension infrastructure generator 926, a comprehension and integration generator 928, and a cognitive network component 930.

The user management and administrative component 922 is responsible for generating individual databases for each user. The database includes various content (videos) obtained by a user, and various corresponding comprehension blocks (generated by the user) and/or obtained with the video. The cognitive information generator 924 obtains content and sets the content into a cognitive structure (comprehension-integrated content). That is, the cognitive information generator 924 performs the operations described above with reference to FIGS. 4A-8B. For example, the cognitive information generator 924 divides the content into CRUs and sets identifiers.

The comprehension infrastructure generator 926 generates various comprehension guides. That is, it helps a content provider/presenter to generate a lesson plan. The operations may include generating user-defined parts, titling user-defined parts, setting identifiers, linking learning material, homework, assignments, etc. to it and perform one or more of the operations described above with reference to FIGS. 3A-8B.

The comprehension and integration generator 928 generates various maps and links described above with reference to the third building block of FIGS. 3A-8B. Using the links and/or maps generated by the comprehension and integration generator 928, one or more users may toggle between learning material and a corresponding portion of the multimedia content.

The cognitive network component 930 facilitates communication among various users e.g., by forming a network in which comments are shared among viewers and/or the presenter. The cognitive network component 930 is configured to provide one or more of the tools for saving comprehension blocks, sharing them with the presenter and/or another user, posting contents. In one or more exemplary embodiments, the cognitive network component 930 saves formed cognitive insights (comprehension) and/or cognitive intelligence (mastery) into the cognitive template.

Many changes may be apparent to those of ordinary skill in the art without departing from the scope and spirit of the described embodiments. The terminology used herein was chosen to best explain the principles of the embodiments, the practical application or technical improvement over technologies found in the market place or to enable ordinary skill in the art to understand the embodiments disclosed herein.

In an exemplary embodiment, the term “computer-readable medium” as used herein refers to any medium that participates in providing instructions to a processor for execution. A computer readable medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having two or more wires, a portable computer diskette such as a floppy disk or a flexible disk, magnetic tape or any other magnetic medium, a hard disk, a random access memory (RAM), a read-only memory (ROM), an erasable programmable read-only memory (EPROM or Flash memory), a memory card, any other memory chip or cartridge, an optical fiber, a portable compact disc read-only memory (CD-ROM), any other optical medium, punchcards, papertape, any other physical medium with patterns of holes, or any other medium from which a computer can read or suitable combination of the foregoing.

In the context of this document, a computer readable medium may be any tangible, non-transitory medium that can contain, or store a program for use by or in connection with an instruction execution system, apparatus, or device.

Another form is signal medium and may include a propagated data signal with computer readable program code embodied therein, for example, in a base band or as part of a carrier wave. Such a propagated signal may take any of a variety of forms, including, but not limited to, the electro-magnetic, optical, or any suitable combination thereof. The signal medium may include coaxial cables, copper wire and fiber optics, including the wires that comprise data bus. The signal medium may be any medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc. or any suitable combination of the foregoing.

Computer program code for carrying out operations for aspects of the exemplary embodiments may be written in any combination of one or more programming languages, including an object oriented programming language such as Java, Smalltalk, C++, .Net or the like and conventional procedural programming languages. The program code may execute entirely on the user's computer, partly on the user's computer, as a stand-alone software package, partly on the user's computer and partly on a remote computer or entirely on the remote computer or server. The remote computer may be connected to the user's computer through any type of network, including a local area network (LAN) or a wide area network (WAN), or the connection may be made to an external computer (for example, through the Internet using an Internet Service Provider).

The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks. Volatile media includes dynamic memory.

Various forms of computer readable media may be involved in carrying one or more sequences of one or more instructions to a processor such as a CPU for execution. For example, the instructions may initially be carried on a magnetic disk from a remote computer. Alternatively, a remote computer can load the instructions into its dynamic memory and send the instructions over a telephone line using a modem. A modem local to a computer system can receive the data on the telephone line and use an infrared transmitter to convert the data to an infrared signal. An infrared detector can receive the data carried in the infrared signal and appropriate circuitry can place the data on the data bus. The bus carries the data to the volatile storage, from which processor retrieves and executes the instructions. The instructions received by the volatile memory may optionally be stored on persistent storage device either before or after execution by a processor. The instructions may also be downloaded into the computer platform via Internet using a variety of network data communication protocols well known in the art.

The flowchart and block diagrams in the Figures illustrate the architecture, functionality, and operation of possible implementations of systems, methods and computer program products according to various exemplary embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur out of the order noted in the figures. For example, two blocks shown in succession may, in fact, be executed substantially concurrently, or two blocks may sometimes be executed in the reverse order, depending upon the functionality involved. It will also be noted that each block of the block diagram and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology as used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or acts for performing the function in combination with other claimed elements as specifically claimed.

The description of the exemplary embodiments has been presented for purposes of illustration and description, but is not intended to be exhaustive or limiting in any form. Many modifications and variations will be apparent to those of ordinary skill in the art without departing from the scope and spirit of the invention. Exemplary embodiments were chosen and described in order to explain operations and the practical applications thereof, and to enable others of ordinary skill in the art to understand various embodiments with various modifications as are suited to the particular use contemplated. That is, various modifications to these embodiments will be readily apparent to those skilled in the art, and the generic principles and specific examples defined herein may be applied to other embodiments without the use of inventive faculty. For example, some or all of the features of the different embodiments discussed above may be combined into a single embodiment. Conversely, some of the features of a single embodiment discussed above may be deleted from the embodiment. Therefore, the present disclosure is not intended to be limited to exemplary embodiments described herein but is to be accorded the widest scope as defined by the features of the claims and equivalents thereof.

What is claimed is:

1. A computer-implemented method of providing cognitive assistance, the method comprising:
generating a cognitive template comprising a plurality of building blocks including a first block for at least one subject, a second block for content associated with the at least one subject, a third block for a map that includes at least one learning objective and at least one link between the at least one subject, the at least one learning objective, and the content, a fourth block for primary episodic units, and a fifth block for semantic meaning of the primary episodic units;
obtaining user input and multimedia data;
adding the at least one subject, the content, and at least one learning objective into the first block, the second block, and the third block, respectively, based on the user input;
dividing the multimedia data into a plurality of episodic units;
adding the plurality of episodic units into the fourth block of the cognitive template;
analyzing each of the plurality of episodic units to generate a respective semantic unit that includes semantic meaning of a respective episodic unit;
adding a plurality of semantic units into the fifth block of the cognitive template;
generating a plurality of links between the plurality of semantic units, the plurality of episodic units, the at least one subject, the content, and the at least one learning objective;
adding the plurality of links into the third block in which each of the at least one learning objective is associated with a portion of the content and an episodic set that includes at least two of the plurality of episodic units; and
providing the multimedia data structured in the cognitive template.

2. The computer-implemented method of claim 1, wherein providing the multimedia data structured in the cognitive template includes:
obtaining additional user input; and
displaying the at least one subject in a main display area based on the user input.

3. The computer-implemented method of claim 1, wherein providing the multimedia data structured in the cognitive template includes:
displaying the at least one learning objective in a display area;
obtaining additional user input in which a learning object from among the at least one learning objective is selected;
determining a respective episodic set and a corresponding semantic set that includes at least two of the plurality of semantic units that are associated with the learning objective based on the plurality of links in the third block; and
synchronously playing the respective episodic set and the corresponding set semantic set.

4. The computer-implemented method of claim 1, wherein providing the multimedia data structured in the cognitive template includes:
toggling, based on additional user input, between the episodic set and the portion of the content associated with the episodic set, wherein the episodic set and the portion of the content are both linked to the same learning objective from among the at least one learning objective based on the plurality of links in the third block.

5. The computer-implemented method of claim 1, further comprising:
obtaining secondary content related to the multimedia data;
adding the secondary content to a sixth block of the cognitive template;
generating at least one content link that connects the secondary content to at least one of the plurality of episodic units, a corresponding learning objective, and a corresponding semantic unit; and
adding the at least one content link to the third block of the cognitive template such that the secondary content is provided based on a selection when viewing the at least one of the plurality of episodic units.

6. The computer-implemented method of claim 5, further comprising:
toggling, based on additional user input, between the plurality of episodic units and the secondary content linked to same one of the at least one learning objective.

7. The computer-implemented method of claim 5, further comprising:
obtaining additional user input with respect to the secondary content, wherein the additional user input demonstrates a level of comprehension of the at least one subject; and
adding the additional user input with the secondary content as a comprehension unit into a seventh block of the plurality of building blocks.

8. The computer-implemented method of claim 7, wherein the secondary content comprises at least one of a task to be completed by a user and wherein the user input includes an input of a content provider and the additional input is of the user.

9. The computer-implemented method of claim 7, further comprising:
determining whether a cognitive insight is formed based on analyzing the plurality of building blocks in the cognitive template.

10. The computer-implemented method of claim 1, further comprising:
obtaining experience data associated with a real-life problem related to the multimedia data;
adding the experience data into an eight block of the plurality of building blocks;
generating at least one application link that connects the experience data to at least one of the plurality of episodic units, a corresponding learning objective, and a corresponding semantic unit; and
adding the at least one application link to the third block of the cognitive template, wherein the experience data is provided based on a selection when viewing the at least one of the plurality of episodic units.

11. The computer-implemented method of claim 10, further comprising:
obtaining additional user input with respect to the real-life problem, wherein the additional user input relates to a personal experience of a user;
adding the additional user input together with the experience data that relates to a mastery by the user of the at least one subject into a ninth block of the plurality of building blocks;
generating at least one mastery link that connects the additional user input together with the experience data to at least one of the plurality of episodic units, a corresponding learning objective, and a corresponding semantic unit; and
adding the at least one mastery link to the third block of the cognitive template.

12. The computer-implemented method of claim 11, further comprising:
determining whether the at least one subject is mastered by the user based on analyzing the plurality of building blocks in the cognitive template.

13. The computer-implemented method of claim 11, further comprising:
determining whether the at least one subject is mastered by the user based on analyzing the ninth block.

14. The computer-implemented method of claim 13, wherein determining whether the at least one subject is mastered by the user includes:
determining whether the mastery is formed based on analyzing a state of completion of the ninth block.

15. The computer-implemented method of claim 1, further comprising:
obtaining additional user input; and
displaying the content of the second block based on the additional user input, wherein the content is a tutorial or a textbook, wherein the content in the second block is linked with at least one episodic unit in the fourth block.

16. An apparatus for providing cognitive assistance, the apparatus comprising:
a memory configured to store computer executable instructions; and
a processor configured to execute the computer executable instructions stored in the memory, which when executed by the processor causes the processor to perform a method comprising:
generating a cognitive template comprising a plurality of building blocks including:
a first block for at least one subject,
a second block for content associated with the at least one subject,
a third block for a map that includes at least one learning objective and at least one link between the at least one subject, the at least one learning objective, and the content,
a fourth block for primary episodic units, and
a fifth block for semantic meaning of the primary episodic units;
obtaining user input and multimedia data;
adding the at least one subject, the content, and at least one learning objective into the first block, the second block, and the third block, respectively, based on the user input;
dividing the multimedia data into a plurality of episodic units;
adding the plurality of episodic units into the fourth block of the cognitive template;
analyzing each of the plurality of episodic units to generate a respective semantic unit that includes semantic meaning of a respective episodic unit;
adding a plurality of semantic units into the fifth block of the cognitive template;
generating a plurality of links between the plurality of semantic units, the plurality of episodic units, the at least one subject, the content, and the at least one learning objective;
adding the plurality of links into the third block in which each of the at least one learning objective is associated with a portion of the content and an episodic set that includes at least two of the plurality of episodic units; and
providing the multimedia data structured in the cognitive template.

17. The apparatus of claim 16, wherein the computer executable instructions further cause the processor to perform providing the multimedia data structured in the cognitive template by:
toggling, based on additional user input, between the episodic set and the portion of the content associated with the episodic set, wherein the episodic set and the portion of the content are both linked to the same learning objective from among the at least one learning objective based on the plurality of links in the third block.

18. The apparatus of claim 16, wherein the computer executable instructions further cause the processor to perform additional operations comprising:
obtaining secondary content related to the multimedia data;
adding the secondary content to a sixth block of the cognitive template;
generating at least one content link that connects the secondary content to at least one of the plurality of episodic units, a corresponding learning objective, and a corresponding semantic unit; and
adding the at least one content link to the third block of the cognitive template such that the secondary content is provided based on a selection when viewing the at least one of the plurality of episodic units.

19. A non-transitory computer-readable storage media that includes code for execution and when executed by a processor is operable to perform operations including:
generating a cognitive template comprising a plurality of building blocks including a first block for at least one subject, a second block for content associated with the at least one subject, a third block for a map that includes at least one learning objective and at least one link between the at least one subject, the at least one learning objective, and the content, a fourth block for primary episodic units, and a fifth block for semantic meaning of the primary episodic units;
obtaining user input and multimedia data;
adding the at least one subject, the content, and at least one learning objective into the first block, the second block, and the third block, respectively, based on the user input;
dividing the multimedia data into a plurality of episodic units;
adding the plurality of episodic units into the fourth block of the cognitive template;
analyzing each of the plurality of episodic units to generate a respective semantic unit that includes semantic meaning of a respective episodic unit;
adding a plurality of semantic units into the fifth block of the cognitive template;
generating a plurality of links between the plurality of semantic units, the plurality of episodic units, the at least one subject, the content, and the at least one learning objective;
adding the plurality of links into the third block in which each of the at least one learning objective is associated with a portion of the content and an episodic set that includes at least two of the plurality of episodic units; and
providing the multimedia data structured in the cognitive template.

20. The non-transitory computer-readable storage media of claim 19, wherein the code causes the processor to perform the operation of providing the multimedia data structured in the cognitive template by:
toggling, based on additional user input, between the episodic set and the portion of the content associated with the episodic set, wherein the episodic set and the portion of the content are both linked to the same learning objective from among the at least one learning objective based on the plurality of links in the third block.

21. The non-transitory computer-readable storage media of claim 19, wherein the code cause the processor to perform additional operations comprising:
obtaining secondary content related to the multimedia data;
adding the secondary content to a sixth block of the cognitive template;
generating at least one content link that connects the secondary content to at least one of the plurality of episodic units, a corresponding learning objective, and a corresponding semantic unit; and
adding the at least one content link to the third block of the cognitive template such that the secondary content is provided based on a selection when viewing the at least one of the plurality of episodic units.
